(19) United States
(12) Patent Application Publication
(10) Pub. No.: US 2007/0247968 A1
(43) Pub. Date: Oct. 25, 2007

(54) Sandwich magnetic stir elements for stirring the contents of vessels

(75) Inventor: Patrick H. Cleveland, Rancho Santa Fe, CA (US)

Correspondence Address: EDWARD W CALLAN, NO. 705 PMB 452, 3830 VALLEY CENTRE DRIVE, SAN DIEGO, CA, 92130, US

(73) Assignee: V & P Scientific, Inc.

(21) Appl. No.: 11/408,489

(22) Filed: Apr. 21, 2006

(51) Int. Cl. B01F 13/08

(52) U.S. Cl. 366/273

(57) ABSTRACT

A magnetic stir element includes a stirrer of nonmagnetic material that is configured for stirring the contents of a vessel. The stirrer includes a pair of opposed cavities on opposite sides of the stirrer and a barrier that separates the opposed cavities. Magnetized magnetic material is disposed in the pair of opposed cavities to provide a magnetic flux axis for the stirrer. The magnetic material is so magnetized and disposed in the pair of separated opposed cavities that the magnetized magnetic material disposed in one of the pair of separated opposed cavities is magnetically attracted to the magnetized magnetic material disposed in the other of the pair of separated opposed cavities to thereby hold the magnetized magnetic material within the pair of separated opposed cavities.

### BACKGROUND OF THE INVENTION

The present invention generally pertains to magnetic stir elements that are used for stirring of the contents of vessels in response to variations in the alignment of magnetic flux lines emanating from a source external to the vessels and is particularly directed to the configuration and composition of magnetic stir elements.

Prior art magnetic stir elements include magnetized magnetic material that is disposed to provide a magnetic flux axis that maintains alignment with the magnetic flux lines emanating from the external source to thereby cause the stir element to tumble, rock back and forth, or spin as the alignment of the externally emanated flux lines vary. One prior art magnetic stir element includes a disk of magnetized magnetic material configured for stirring the contents of a vessel and having oppositely polarized sides. Another prior art magnetic stir element includes an elongated component of magnetized magnetic material that is configured for stirring the contents of a vessel and has oppositely polarized ends.

In some prior art magnetic stir elements, the magnetic material is magnetized stainless steel. In other prior art magnetic stir elements, the magnetic material is a permanent magnet, which is preferred for enhancing the responsiveness of the magnetic stir elements to variations of magnetic flux lines emanating from a magnetic field source of limited magnetic field strength, especially when the stir elements are disposed for stirring the contents of large two-dimensional array of vessels.

The magnetic material of prior art magnetic stir elements is coated with or encased within a protective material that prevents the magnetic material from corroding and/or from leaching into and possibly reacting with the contents of the vessel that are being stirred. One protective material that is used in prior art magnetic stir elements for coating both stainless steel and permanent magnets is Parylene (Di-Para-Xylylene). However, Parylene is soft and can be worn away by extended use.

In some prior art magnetic stir elements, the magnetized magnetic material is encapsulated in a stirrer of nonmagnetic material that is configured for stirring the contents of a vessel by tumbling within the vessel. The magnetized magnetic material is disposed in the stirrer to provide a magnetic flux axis for the stirrer.

A preferred nonmagnetic material for the stirrers of prior art magnetic stir elements is PTFE (Polytetrafluoroethylene) plastic material. PTFE has the lowest coefficient of friction of any known solid material and is very non-reactive with other materials.

### SUMMARY OF THE INVENTION

The present invention provides a magnetic stir element, comprising: a stirrer of nonmagnetic material that is configured for stirring the contents of a vessel, wherein the stirrer includes a pair of opposed cavities on opposite sides of the stirrer and a barrier that separates the opposed cavities; and magnetized magnetic material disposed in the pair of opposed cavities to provide a magnetic flux axis for the stirrer; wherein the magnetic material is so magnetized and disposed in the pair of separated opposed cavities that the magnetized magnetic material disposed in one of the pair of separated opposed cavities is magnetically attracted to the magnetized magnetic material disposed in the other of the pair of separated opposed cavities to thereby hold the magnetized magnetic material within the pair of separated opposed cavities. The barrier is sandwiched between the magnetized magnetic material that is disposed in the pair of separated opposed cavities and thereby provides a base upon which the magnetized magnetic material is held within the pair of separated opposed cavities.

The present invention also provides a process of manufacturing a magnetic stirrer, comprising the steps of:

(a) providing a stirrer of nonmagnetic material that is configured for stirring the contents of a vessel;

(b) providing a pair of opposed separated cavities within the stirrer on opposite sides of a barrier within the stirrer; and

(c) disposing magnetized magnetic material in the pair of opposed cavities to provide a magnetic flux axis for the stirrer,

wherein the magnetic material is so magnetized and disposed in the pair of separated opposed cavities that the magnetized magnetic material disposed in one of the pair of separated opposed cavities is magnetically attracted to the magnetized magnetic material disposed in the other of the pair of separated opposed cavities to thereby hold the magnetized magnetic material within the pair of separated opposed cavities.

The present invention readily facilitates the disposition of the permanent magnets in magnetic stir elements.

The present invention particularly facilitates the inclusion of NdFeB permanent magnets in magnetic stir elements that include a PTFE stirrer. NdFeB permanent magnets are preferred for enhancing the responsiveness of the magnetic stir elements because of the very high magnetic field strength of NdFeB permanent magnets. NdFeB has the highest magnetic energy of any material that is currently available for commercial applications. Heretofore, NdFeB permanent magnets have not been included in commercially manufactured magnetic stir elements that include PTFE stirrers because the step of encapsulating the permanent magnets in the prior art PTFE stirrers necessarily heated the PTFE to a temperature that is so high that when NdFeB permanent magnets are encapsulated in the PTFE plastic material the magnetic field strength of the NdFeB permanent magnets is severely diminished.

For other stirring applications in which the very high magnetic field strength provided by NdFeB permanent magnets is not required, alternative permanent magnets that do not include NdFeB are disposed in the pair of opposed cavities of the stirrer. Suitable alternative permanent magnet materials include SmCo, Alnico alloys and Ferrites.

The present invention also facilitates the manufacture of stirrers having different and unusual shapes rather inexpensively since the stirrers can be machined, punched or cut with dyes from sheets as opposed to being molded. Another advantage is that by using large “flat” shapes greater fluid movement is affected during stirring. Still another advantage is that the shape can be customized to specifically conform to the inside of a given vessel to thereby maximize stirring efficiency.

Additional features of the present invention are described with reference to the detailed description of the preferred embodiments.

### BRIEF DESCRIPTION OF THE DRAWING

FIG. 1 is a perspective view of one embodiment of an elongated tubular magnetic stir element according to the present invention.

FIG. 2 is a sectional view of the magnetic stir element of FIG. 1 taken along the axis of elongation of the stir element.

FIG. 3 is a perspective view of an embodiment of a disk shaped magnetic stir element according to the present invention.

FIG. 4 is a side a sectional view of the magnetic stir element of FIG. 3 taken perpendicular to the broad surfaces of the stir element.

FIG. 5 is a perspective view of another embodiment of an elongated tubular magnetic stir element according to the present invention.

FIG. 6 is a side sectional side view of the magnetic stir element of FIG. 5 taken along the axis of elongation of the stir element.

FIG. 7 is a top plan view of still another embodiment of an elongated tubular magnetic stir element according to the present invention.

FIG. 8 is a top plan view of yet another embodiment of an elongated tubular magnetic stir element according to the present invention.

FIG. 9 is a perspective view of an exemplary embodiment of an elongated tubular magnetic stir element according to the present invention that is configured to conform to the inside of a vessel of a given shape.

### DETAILED DESCRIPTION

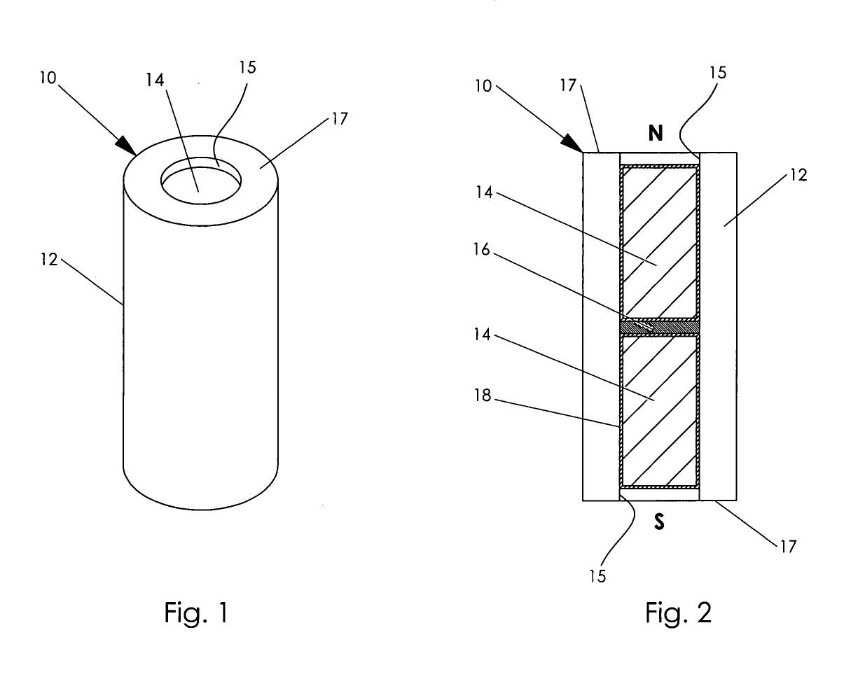

Referring to FIGS. 1 and 2, one embodiment of an elongated tubular magnetic stir element 10 according to the present invention includes a stirrer 12 of a nonmagnetic, non-reactive, durable material, such as PTFE plastic, and two permanent magnets 14. The stirrer 12 is a tube that is configured for stirring the contents of a vessel. A pair of opposed cylindrical cavities 15 are defined by opposite ends of the tube 12.

A barrier 16 is inserted into the tube 12 to separate the opposed cylindrical cavities 15. The barrier 16 is a disk that is slightly larger than the inside diameter of the tube 12 that may be either magnetic material or nonmagnetic material. In some embodiments, the barrier disk 16 is stainless steel.

The permanent magnets 14 are recessed within the pair of cylindrical cavities 15 at a level below the level of the respective surfaces 17 at the opposite ends of the tube 12 that adjoin the pair of cavities 15, to thereby prevent contact between the permanent magnets 14 and the vessel in which the magnetic stir element 10 is inserted for stirring the contents thereof.

In all of the embodiments described herein, the permanent magnets 14 are made of a permanent magnet material, such as NdFeB, SmCo, Alnico alloys and Ferrites. Preferably, the permanent magnet material is first shaped for disposition in the opposed cavities of the particular embodiment of the stirrer in which they are to be disposed before the permanent magnet material is magnetized to provide the permanent magnets.

In the embodiment shown in FIGS. 1 and 2, prior to magnetization of the permanent magnet material, cylinders of the permanent magnet material having a diameter that is slightly less than the inside diameter of the tube 12 and of a desired length are assembled to fit within the pair of cylindrical cavities 15.

The permanent magnet material cylinders are then coated with a protective material, such as Parylene. Two cylindrical permanent magnets 14, having a protective coating 18 are provided by magnetizing the pair of coated rods cylinders so that the opposite ends of the rods cylinders are of opposite magnetic polarity.

By recessing the coated permanent magnets 14 within the cavities 15, the protective-material-coating 18 is protected from being worn away by contact with the inside of a vessel in which the magnetic stir element 10 is inserted. This is particularly advantageous when the protective material is Parylene.

The coated permanent magnets 14 are disposed in the pair of opposed cavities 15 to provide a magnetic flux axis for the stirrer 12. The permanent magnets 14 are so magnetized and disposed in the pair of separated opposed cavities 15 that the permanent magnet 14 disposed in one of the pair of separated opposed cavities 15 is magnetically attracted to the permanent magnet 14 disposed in the other of the pair of separated opposed cavities 15 to thereby hold the permanent magnets 14 within the pair of separated opposed cavities. The barrier 16, which is slightly larger in diameter than the inside diameter of the tube 12, is sandwiched between the permanent magnets 14 that are disposed in the pair of separated opposed cavities 15 and thereby provides a base upon which the permanent magnets 14 are held within the pair of separated opposed cavities 15.

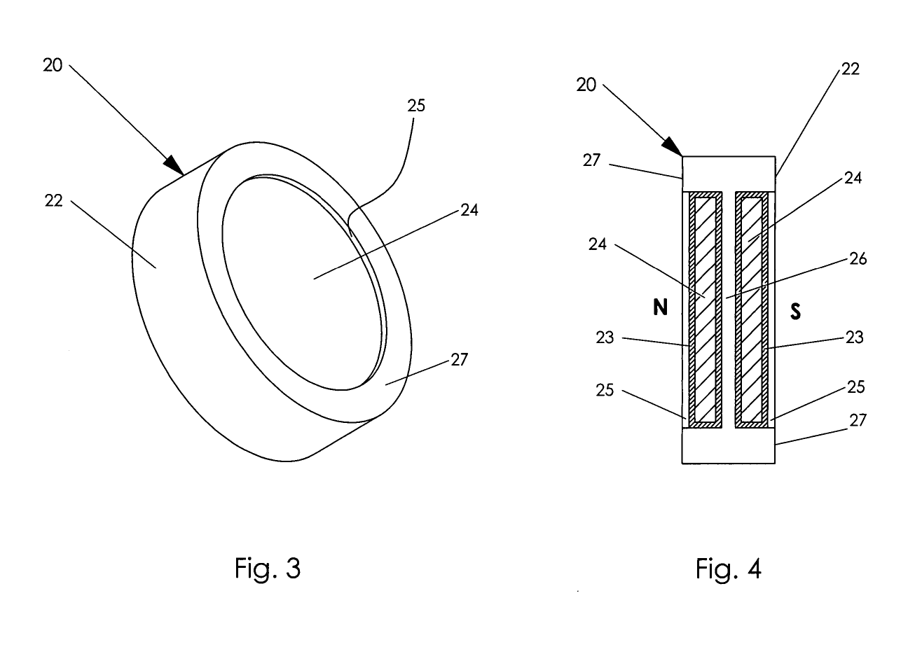

Referring to FIGS. 3 and 4, one embodiment of a disk-shaped magnetic stir element 20 according to the present invention includes a stirrer 22 of nonmagnetic, non-reactive, durable material, such as PTFE plastic, and two disk-shaped permanent magnets 24 having a protective coating 23. The stirrer 22 is a generally flat disk that is configured for stirring the contents of a vessel. A pair of opposed cylindrical cavities 25 are defined in opposite broad sides of the disk-shaped stirrer 22.

The portion of the disk-shaped stirrer 22 between the opposed cavities 25 is a barrier 26 that separates the opposed cavities 25. The two disk-shaped permanent magnets 24 are recessed within the pair of cylindrical cavities 25 at a level below the level of the respective opposite broad surfaces 27 of the disk-shaped stirrer 22 that adjoin the pair of cavities 25, to thereby prevent contact between the permanent magnets 24 and the vessel in which the magnetic stir element 20 is inserted for stirring the contents thereof.

The disk-shaped permanent magnets 24 are so magnetized that the opposite broad surfaces thereof are of opposite magnetic polarity. The permanent magnets 24 are coated with a protective material 23, such as Parylene.

By recessing the coated permanent magnets 24 within the cavities 25, the protective-material-coating 23 is protected from being worn away by contact with the inside of a vessel in which the magnetic stir element 20 is inserted.

The coated permanent magnets 24 are disposed in the pair of opposed cavities 25 to provide a magnetic flux axis for the stirrer 22. The permanent magnets 24 are so magnetized and disposed in the pair of separated opposed cavities 25 that the permanent magnet 24 disposed in one of the pair of separated opposed cavities 25 is magnetically attracted to the permanent magnet 24 disposed in the other of the pair of separated opposed cavities 25 to thereby hold the permanent magnets 24 within the pair of separated opposed cavities 25. The barrier 26 that is sandwiched between the permanent magnets 24 provides a base upon which the permanent magnets 24 are held within the pair of separated opposed cavities 25.

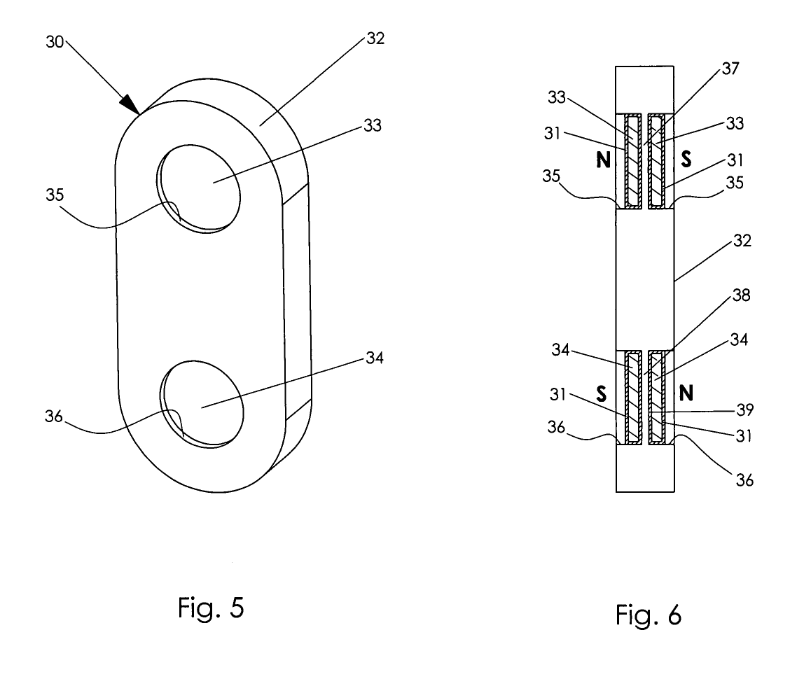

Referring to FIGS. 5 and 6, another embodiment of an elongated magnetic stir element 30 according to the present invention includes a stirrer 32 of nonmagnetic, non-reactive, durable material, such as PTFE plastic, and two pairs of disk-shaped permanent magnets 33, 34. The stirrer 32 has a generally flat elongated configuration for stirring the contents of a vessel. Two pairs of opposed cylindrical cavities 35, 36 are defined in the opposite broad sides of the elongated stirrer 32 proximate to the opposite ends of the stirrer 32. In the embodiment shown in FIGS. 5 and 6, the ends of the opposite broad sides of the elongated stirrer 32 have a semicircular shape. In other embodiments the ends of the opposite broad sides of an elongated stirrer having two pairs of opposed cylindrical cavities respectively proximate to the opposite ends of the stirrer have a shape other than semicircular.

The portions of the elongated stirrer 32 between the respective pairs of opposed cavities 35, 36 are barriers 37, 38 that separate the respective opposed cavities 35, 36. Two disk-shaped permanent magnets 33 are recessed within one pair of opposed cylindrical cavities 35 at a level below the level of the respective opposite broad surfaces 39 of the elongated stirrer 32 that adjoin the pair of opposed cavities 35, and two disk-shaped permanent magnets 34 are recessed within the other pair of opposed cylindrical cavities 36 at a level below the level of the respective opposite broad surfaces 39 of the elongated stirrer 32 that adjoin the pair of opposed cavities 35, to thereby prevent contact between the permanent magnets 33, 34 and the vessel in which the magnetic stir element 30 is inserted for stirring the contents thereof.

The disk-shaped permanent magnets 33, 34 are so magnetized that the opposite broad surface thereof are of opposite magnetic polarity. The permanent magnets 33, 34 are coated with a protective material 31, such as Parylene.

By recessing the coated permanent magnets 33, 34 within the cavities 35, 36, the protective-material-coating 31 is protected from being worn away by contact with the inside of a vessel in which the magnetic stir element 30 is inserted.

The pair of coated permanent magnets 33 is disposed in the pair of opposed cavities 35 to provide a magnetic flux axis that is oppositely polarized from the magnetic flux axis provided by the pair of permanent magnets 34 that is disposed in the other pair of opposed cavities 36, to provide a magnetic flux axis for the stirrer 32.

The permanent magnets 33 are so magnetized and disposed in the pair of separated opposed cavities 35 that the permanent magnet 33 disposed in one of the pair of separated opposed cavities 35 is magnetically attracted to the permanent magnet 33 disposed in the other of the pair of separated opposed cavities 35 to thereby hold the permanent magnets 33 within the pair of separated opposed cavities 35. The barrier 37 that is sandwiched between the permanent magnets 33 provides a base upon which the permanent magnets 33 are held within the pair of separated opposed cavities 35.

The permanent magnets 34 are so magnetized and disposed in the pair of separated opposed cavities 36 that the permanent magnet 34 disposed in one of the pair of separated opposed cavities 36 is magnetically attracted to the permanent magnet 34 disposed in the other of the pair of separated opposed cavities 36 to thereby hold the permanent magnets 34 within the pair of separated opposed cavities 36. The barrier 38 that is sandwiched between the permanent magnets 34 provides a base upon which the permanent magnets 34 are held within the pair of separated opposed cavities 35.

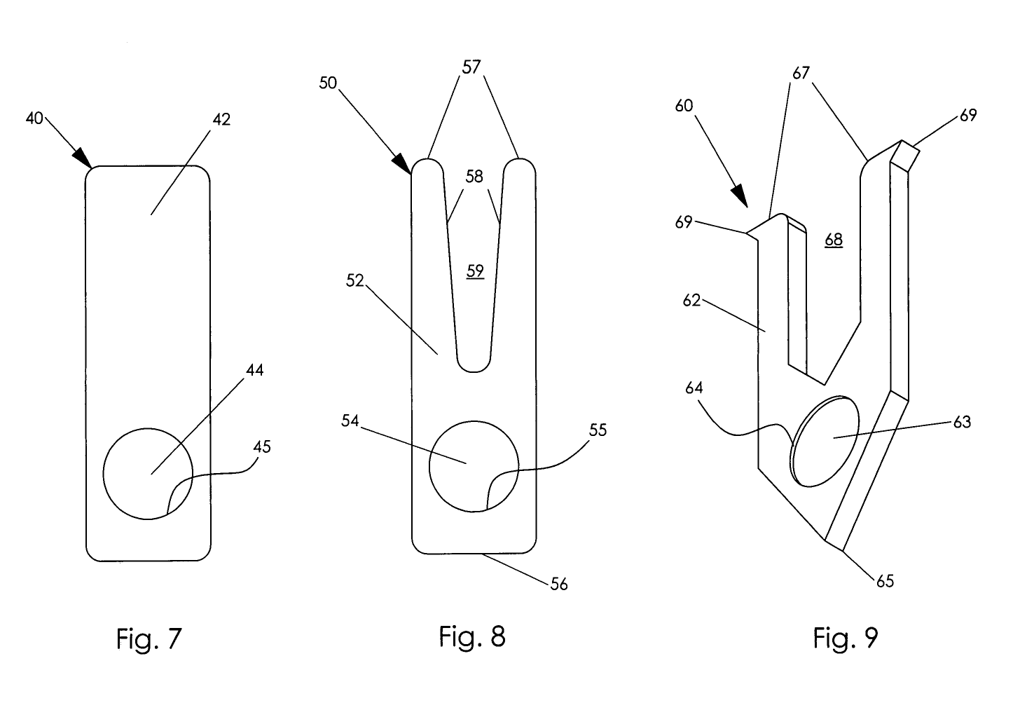

Referring to FIG. 7, still another embodiment of an elongated magnetic stir element 40 according to the present invention includes a stirrer 42 of nonmagnetic, non-reactive, durable material, such as PTFE plastic, and one pair of disk-shaped permanent magnets 44 that are disposed in a pair of opposed cylindrical cavities 45, which are defined in the opposite broad sides of the elongated stirrer 42 proximate to only one end of the stirrer 42.

The stirrer 42 has a generally flat elongated configuration for stirring the contents of a vessel. In the embodiment shown in FIG. 7, the opposite broad sides of the elongated stirrer 42 have a generally rectangular shape with the corners being rounded. In other embodiments the opposite broad sides of an elongated stirrer having one pair of opposed cylindrical cavities proximate to only one end of the stirrer have a shape that is other than generally rectangular.

In other embodiments the broad sides of an elongated stirrer having one pair of opposed cylindrical cavities proximate to only one end of the stirrer have a shape that is other than generally rectangular.

In other respects, the elongated magnetic stir element 40 is constructed in the same manner as the magnetic stir element 30 described above with reference to FIGS. 5 and 6.

Referring to FIG. 8, yet another embodiment of an elongated magnetic stir element 50 according to the present invention includes a stirrer 52 of nonmagnetic, non-reactive, durable material, such as PTFE plastic, and one pair of disk-shaped permanent magnets 54 that are disposed in a pair of opposed cylindrical cavities 55, which are defined in the opposite broad sides of the elongated stirrer 52 proximate to only one end of the stirrer 52.

The stirrer 52 has a generally flat elongated configuration for stirring the contents of a vessel. One end 56 of the opposite broad sides of the elongated stirrer 52 has a generally rectangular shape with the corners being rounded and the other end 57 of the elongated stirrer 52 has a pair of blades 58 that extend generally parallel to the axis of elongation of the stirrer 52 and define an elongated space 59 between the blades 58 that permits a pipette or probe (not shown) to be inserted between the blades 58 to a relatively deep level within a vessel in comparison the level to which a pipette or probe may be inserted when using the elongated magnetic stir element 40 shown in FIG. 7.

In other respects, the elongated magnetic stir element 50 shown in FIG. 8 is constructed in the same manner as the magnetic stir element 40 described above with reference to FIGS. 5, 6 and 7.

Referring to FIG. 9, a further embodiment of an elongated magnetic stir element 60 according to the present invention includes a stirrer 62 of nonmagnetic, non-reactive, durable material, such as PTFE plastic, and one pair of disk-shaped permanent magnets 63 that are disposed in a pair of opposed cylindrical cavities 64, which are defined in the opposite broad sides of the elongated stirrer 62 proximate to only one end of the stirrer 62.

The stirrer 62 has a generally flat elongated configuration for stirring the contents of a vessel. One end 65 of the stirrer 62 has a generally convergent shape and the other end 66 of the elongated stirrer 62 has a pair of blades 67 that extend generally parallel to the axis of elongation of the stirrer 52 and define an elongated space 68 between the blades 67. The blades 67 terminate in ears 69 that extend generally outward from the blades 67 relative to the axis of elongation of the stirrer 62 to thereby prevent most of the magnetic stir element 60 from contacting the interior of the vessel.

The convergent shape of the one end 65 of the stirrer 62 enables the magnetic stir element 60 to reach a deeper level within a vessel having a convergent-shaped closed end than can be reached with a magnetic stir element which does not have a generally convergent shape at one end.

In other embodiments the broad sides of an elongated stirrer having one pair of opposed cylindrical cavities proximate to only one end of the stirrer have a shape that is other than generally rectangular.

In other respects, the elongated magnetic stir element 40 is constructed in the same manner as the magnetic stir element 30 described above with reference to FIGS. 5, 6, 7 and 8.

In still other embodiments (not shown) the various aspects of the different embodiments described herein are combined with one another to the extent that they are not incompatible with each other.

Examples of stirring systems in which magnetic stir elements are used are described in U.S. Pat. No. 6,176,609 and in U.S. patent application Ser. No. 11/166,831, the disclosures of which are incorporated herein by reference thereto.

Preferred embodiments of the magnetic stir elements are dimensioned for stirring the contents of vessels that are included within arrays of vessels, such as microplate wells.

The advantages specifically stated herein do not necessarily apply to every conceivable embodiment of the present invention. Further, such stated advantages of the present invention are only examples and should not be construed as the only advantages of the present invention.

While the above description contains many specificities, these should not be construed as being necessarily required for use of the present invention or as limitations on the scope of the present invention, but rather as examples of the embodiments described herein. Other variations are possible and the scope of the present invention should be determined not by the embodiments described herein but rather by the claims and their legal equivalents.

Regarding the method claims, except for those steps that can only occur in the sequence in which they are recited, and except for those steps for which the occurrence of a given sequence is specifically recited or must be inferred, the steps of the method claims do not have to occur in the sequence in which they are recited.

1. A magnetic stir element, comprising:
a stirrer of nonmagnetic material that is configured for stirring the contents of a vessel, wherein the stirrer includes a pair of opposed cavities on opposite sides of the stirrer and a barrier that separates the opposed cavities; and
magnetized magnetic material disposed in the pair of opposed cavities to provide a magnetic flux axis for the stirrer;
wherein the magnetic material is so magnetized and disposed in the pair of separated opposed cavities that the magnetized magnetic material disposed in one of the pair of separated opposed cavities is magnetically attracted to the magnetized magnetic material disposed in the other of the pair of separated opposed cavities to thereby hold the magnetized magnetic material within the pair of separated opposed cavities.

2. A magnetic stir element according to claim 1, wherein the magnetized magnetic material includes NdFeB permanent magnets and the nonmagnetic stirrer material includes PTFE.

3. A magnetic stir element according to claim 2, wherein the NdFeB permanent magnets are recessed within the pair of cavities at a level below the level of the respective surfaces adjoining the pair of cavities.

4. A magnetic stir element according to claim 3, wherein the NdFeB permanent magnets are coated with a protective material.

5. A magnetic stir element according to claim 1, wherein the magnetized magnetic material is recessed within the pair of cavities at a level below the level of the respective surfaces adjoining the pair of cavities.

6. A magnetic stir element according to claim 1, wherein the magnetized magnetic material is coated with a protective material.

7. A magnetic stir element according to claim 1, wherein the stirrer has a generally flat configuration.

8. A magnetic stir element according to claim 1, wherein the stirrer has a tubular configuration, with the pair of opposed cavities being defined by opposite ends of the tube.

9. A magnetic stir element according to claim 1, wherein the stirrer is elongated, the pair of opposed cavities are proximate to only one end of the stirrer and the other end of the stirrer has blades that extend generally parallel to the axis of elongation of the stirrer from opposed sides of the stirrer and define an elongated space between the blades.

10. A magnetic stir element according to claim 9, wherein the blades terminate in ears that extend generally outward from the blades relative to the axis of elongation of the stirrer.

11. A magnetic stir element according to claim 9, wherein the other end of the elongated stirrer has a generally convergent shape.

12. A magnetic stir element according to claim 9, wherein the stirrer is elongated and includes a pair of said opposed cavities proximate to each end of the stirrer; and
wherein the magnetized magnetic material disposed in one pair of opposed cavities provides a magnetic flux axis that is oppositely polarized from the magnetic flux axis provided by the magnetized magnetic material disposed in the other pair of opposed cavities.

13. A process of manufacturing a magnetic stirrer, comprising the steps of:
(a) providing a stirrer of nonmagnetic material that is configured for stirring the contents of a vessel;
(b) providing a pair of opposed separated cavities within the stirrer on opposite sides of a barrier within the stirrer; and
(c) disposing magnetized magnetic material in the pair of opposed cavities to provide a magnetic flux axis for the stirrer,
wherein the magnetic material is so magnetized and disposed in the pair of separated opposed cavities that the magnetized magnetic material disposed in one of the pair of separated opposed cavities is magnetically attracted to the magnetized magnetic material disposed in the other of the pair of separated opposed cavities to thereby hold the magnetized magnetic material within the pair of separated opposed cavities.

14. A process according to claim 13, further comprising the steps of:
(d) shaping the permanent magnetic material for said disposition in the pair of opposed cavities;
(e) magnetizing the shaped the permanent magnetic material to provide permanent magnets; and
(f) coating the shaped permanent magnets with a protective material;
wherein the coated shaped permanent magnets are disposed within the pair of opposed cavities in accordance with step (c).

15. A process according to claim 14, wherein steps (a) and (b) comprise the step of:
(g) providing a stirrer having a tubular configuration, with the pair of opposed cavities being defined by opposite ends of the tube.

16. A process according to claim 13, wherein steps (a) and (b) comprise the step of:
(d) providing a stirrer having a tubular configuration, with the pair of opposed cavities being defined by opposite ends of the tube.

17. A process according to claim 13, wherein the magnetized magnetic material includes NdFeB and the nonmagnetic stirrer material includes PTFE.
